(19) United States
(12) Patent Application Publication
(10) Pub. No.: US 2026/0248155 A1
(43) Pub. Date: Aug. 27, 2026

(54) METHOD FOR PRODUCING A FOOD PRODUCT OR A PRELIMINARY FOOD PRECURSOR

(71) Applicant: Project Eaden GmbH, Berlin (DE)

(72) Inventor: David SCHMELZEISEN, Berlin (DE)

(21) Appl. No.: 18/878,224

(22) PCT Filed: May 11, 2023
(86) PCT No.: PCT/EP2023/062686

§ 371 Date: Dec. 23, 2024

(30) Foreign Application Priority Data
Jun. 22, 2022 (EP) 22180349.7
Nov. 10, 2022 (WO) PCT/EP2022/081475

(51) Int. Cl. A23J 3/26; A23J 3/22; A23P 20/12; A23P 20/20; A23P 30/25

(52) U.S. Cl. CPC A23J 3/26; A23J 3/227; A23P 20/12; A23P 20/20; A23P 30/25

(57) ABSTRACT

A method for producing a food product is disclosed. The method includes
pulling first and second continuous food precursors in a conveying direction,
orientationally arranging the first and second continuous food precursors orthogonally to the conveying direction to form a continuous strand,
conveying the continuous strand toward a shaping device via tractive forces,
forming a shaped article by applying compressive forces having at least one compressive force component orthogonal to the conveying direction to a first portion of the continuous strand,
cutting the continuous strand to form a strand portion from a second portion of the continuous strand and a food product from the shaped article, and
dispensing the shaped article and the food product. A control method, a food product, and a food production machine are also disclosed.

The present invention relates to a method for producing a food product, in particular a meat substitute product, and to a method for producing a continuous food precursor for producing such a food product. The invention also relates to a control method for controlling an oriented arrangement of continuous food precursors for producing a food product, to a food product and to a food production machine for producing a food product, in particular a meat substitute product.

There are many different methods for producing a food product. Such food products may have a structure that emulates the structure of meat, fish or sausage products. These have a mostly fibrous structure in common. The food product may consist entirely of plant-based starting materials or may contain animal, plant-based and mycelium-based starting materials or raw materials and may consist of both plant-based and animal starting materials.

This poses challenges, not only in the visual imitation of meat, fish or sausage products, in particular with regard to proper texturising, but also in the imitation of processing and eating characteristics such as roasting behavior, bite resistance/elasticity, bolus formation, rheology and the retention or release of water. For example, meat contains a high proportion of water, which is stored and evenly distributed in fibrous connective tissue. The Maillard reaction also occurs on the surface of meat when it is heated. This refers to a complex reaction of fats, protein and polysaccharides when heated, which results in surface browning and a slightly sweet taste. Some types of meat also contain finely distributed fat, which is an important flavor carrier and gives the meat a special taste in addition to its appearance, such as fine marbling.

What is also characteristic of meat and fish products is that a piece of it is not normally completely symmetrical, but rather that the arrangements of the fibers vary in shape and position within the piece.

In summary, the topology of the food product plays a crucial role in the formation of a meat-like structure. Topology is understood here to mean the geometry, distribution and orientation of precursor products in the food product. For example, relatively fine food precursors provide a relatively large surface, which fosters surface reactions. A specific distribution of cavities and food precursors in relation to each other also results in the food product having a specific profile of characteristics. The topology of the food precursors themselves can also influence the profile of characteristics of the food product.

Known methods of producing food products and producing food precursors mostly allow the food precursors to be oriented to only a limited degree relative to each other and are therefore limited with regard to setting up a desired composition and/or geometry and/or topology of the food product. For example, depositing techniques such as 3D printing do not allow precursors to be deposited in all spatial directions. This is concomitant with insufficient control of the water absorption capacity of the food product. Another factor is that such food products have so far been unable to convincingly imitate the texture and firmness of meat. For example, the use of plant-based fibers in meat substitute products, which are generally only present as short or long fibers, results in shortcomings in the imitation of meat. One major challenge is to mimic the inhomogeneous properties of meat with regard to the desired texture. For example, known methods of producing food products are inadequate at allowing different product areas or textures to be formed and arranged along the entire length of the product in such a way that a natural appearance is created. Only rarely do they allow a continuous production process. This can result in more rejects and/or in greater complexity of the production facilities due to additional steps that the process must involve.

For example, a method for producing meat substitute products, in which a fibrous muscle tissue analog comprising fibers with a relatively short fiber length is produced by high-temperature texturization, is known from GB2605746 A. These fibers are then separated by compression using rolls or a press. The short fiber lengths do not allow sufficient twisting. The fibrous muscle tissue analog is produced in a batch process in which it is not possible to adjust the topology of the fibers of the muscle tissue analog along the length of the product. It also depends significantly on the arrangement of the fibers within the precursor. To obtain a food product, this muscle tissue analog is fed to further processing steps for compression. Such batch processes are also disadvantageous in economic terms, as they involve longer production times. In particular, the food precursors for the actual shaping of the food product are produced discontinuously.

A depositing technique in which fiber bundles are produced and deposited is known from US 2023054944 A1. These fiber bundles serve as food precursors and are deposited in a depositing process similar to 3D printing. In this case also, the food precursors are produced discontinuously, and due to the process of depositing the fiber bundles, their orientation relative to each other is limited by the depositing process, and a three-dimensional orientation of the fibers is not possible. Finally, changing the topology is only ever possible in one plane at a time, which limits production speeds.

The object of the present invention was therefore to overcome at least one of the disadvantages known from the prior art. The aim, in particular, is to improve the adjustment of the food product topology, i.e., the position and arrangement of precursors and structure-forming components within the food product, and to increase the variety of producible variants that can be produced. In particular, the water absorption capacity is to be enhanced. It is also desirable to raise the efficiency of a method for producing food products and food precursors, and of a corresponding food production machine.

In a first aspect according to claim 1, the invention achieves the object specified above by a method for producing a food product, in particular a meat substitute product.

According to the first aspect, the invention proposes that the method comprises the following steps:
pulling at least a first continuous food precursor and a second continuous food precursor in a conveying direction,
orientationally arranging the first continuous food precursor pulled in the conveying direction relative to the second continuous food precursor pulled in the conveying direction and orthogonally to the conveying direction to form a continuous oriented strand,
conveying the continuous strand in the direction of a shaping device in the conveying direction under the action of tractive forces,
forming a shaped article by means of the shaping device applying compressive forces having at least one compressive force component orthogonal to the conveying direction, and
cutting the continuous strand into a strand portion and the shaped article connected to the continuous strand into a food product,
dispensing the shaped article and the food product from the shaping device.

A food product is understood in the context of the invention to be a food product having a length that is limited by production engineering factors. The length of the food product is limited, for example, by the step of cutting the continuous strand or the shaped article. The food product may also be a food product that is several hundred centimeters long, which may then be further portioned. Cutting is preferably carried out in a sectional plane whose surface normal forms an angle greater than 0° and less than 180°, in particular greater than 45° and less than 135° to the conveying direction. In other words, cutting is not carried out parallel to the conveying direction, but at an angle relative thereto. It should be understood that the sectional plane can also be formed by tearing and by other separation methods. In the context of the invention, the expression “continuous” is understood analogously to the meaning of the expression in the field of textile engineering. This means that a continuous fiber can theoretically be spun endlessly and is not subject to any natural limitation. The same also applies to the continuous food precursors. The continuous food precursors are produced artificially and their length is not limited by production engineering factors, so the continuous food precursors according to the invention can theoretically be provided in endless lengths, although this is not the case in practice. The same also applies to a continuous strand produced from these continuous food precursors. Given that the continuous food precursors can theoretically be produced endlessly, a strand formed from these continuous food precursors is also theoretically endless. Accordingly, a shaped article formed from such a continuous strand is also endless until such time as it is cut into a food product.

According to the invention, the conveying direction is understood to be the direction in which the continuous food precursors and the continuous strand connected to and formed from them is moved. What is meant here is the general conveying direction, although the continuous food precursors and the continuous strand can also be moved with components of movement that deviate from the conveying direction.

The shaped article can be a preform that is converted into a final product shape by further consolidation steps and/or separation steps and is therefore only close in shape to its final shape. Alternatively, the shaped article may already have the final contour of the food product at least in a sectional plane orthogonal to the conveying direction. In this case, there is not need for the shaped article to undergo any further consolidation steps in order to produce the food product.

Orientationally arranging the first continuous food precursor relative to the second continuous food precursor and orthogonally to the conveying direction is understood to mean that the position of the first continuous food precursor in at least one plane orthogonal to the conveying direction relative to the position of the second continuous food precursor in that plane is defined. Within the food products to be produced, the continuous food precursors thus extend in the conveying direction, but are positioned discretely in relation to each other orthogonally to the conveying direction. This means that the precursors assume varying angles and distances in relation to a central axis of the continuous strand or the shaped article or the food product running parallel to the conveying direction, which angles and distances can be adjusted in a controlled manner along the central axis. As a result, the first food precursor and the second food precursor also assume varying angles and distances from each other. If there is a plurality of first food precursors, the individual first food precursors also adopt varying angles and distances relative to each other.

The shaped article is formed by applying compressive forces having at least one compressive force component orthogonal to the conveying direction. This produces cohesion between the first continuous food precursor and the second continuous food precursor in the continuous strand or in a strand portion produced by previously cutting the continuous strand.

It should be understood that the separation step is optionally performed before the shaped part is formed. In this case, the continuous strand is cut into a strand portion and the strand portion is shaped into the shaped article. Alternatively, the cutting step can also be carried out before the forming step. In this case, the continuous strand is at least partly reshaped such that a section of the continuous strand forms the shaped article. The shaped article that is formed is then separated from the continuous strand. The step of conveying the shaped article in the conveying direction can be carried out and/or repeated at any stage of the process.

The inventor advantageously realized that a defined orientation in the conveying direction can be achieved by orientationally arranging continuous food precursors relative to each other. According to the invention, this orientation of the first continuous food precursor relative to the second continuous food precursor is not necessarily constant in the conveying direction, but can preferably also be varied. This allows targeted setting of a desired topology in the conveying direction and thus along the longitudinal extension of the food product, which topology is defined by the first continuous food precursor and the second continuous food precursor. Due to the shaped article being formed by applying compressive forces having at least one compressive force component orthogonal to the conveying direction, in such a way that cohesion is created between the first continuous food precursor and the second continuous food precursor, the topology of the continuous food precursors itself is also retained. If, for example, the first or the second continuous food precursor comprises fibers having anisotropic material properties, then these anisotropic properties are also retained in the subsequent food product. Producing the shaped article on the basis of continuous food precursors also allows a continuous process for feeding and orienting the continuous precursors in a continuous strand, which can then either be reshaped in portions or divided into food products after reshaping.

Conveying the continuous strand by applying tractive forces ensures that the orientation of the first continuous food precursor relative to the second continuous food precursor is maintained. According to the method, the tractive forces are adjusted in such a way that any tearing of the precursors, which are delicate in most cases, is prevented. Processing continuous food precursors poses a particular challenge compared to the processing of technical textiles or plastics. The tensile strengths of such continuous food precursors are significantly lower to ensure that the food product is pleasant to eat.

Developments of the invention are specified in the dependent claims, which develop the concept of the invention with respect to advantageous features in the context of the stated object, and with regard to further advantages.

The step of forming the shaped article is preferably carried out in a continuous shaping tool, and the step of applying the compressive forces is performed progressively and/or evenly on a surface of the continuous strand. The continuous strand is preferably conveyed under traction through the continuous shaping tool. The progressive build-up of pressure and/or the uniform application of forces onto the surface of the continuous strand reduces or completely prevents peak pressures. This prevents the continuous food precursors in the continuous strand from being torn by peak pressures. The fact that even small pressure peaks can lead to partial tearing of the continuous food precursors, particularly when conveying the continuous strand into the shaping tool under traction is taken into account here. The complex handling of continuous food precursors is thus addressed.

It is further preferred that the step of pulling the first continuous food precursor and/or the second continuous food precursor in the conveying direction preferably comprises, as a substep, pultruding the first continuous food precursor and/or the second continuous food precursor from a production device by applying a tractive force having at least one force component in the conveying direction. Pultruding the continuous food precursors from a production device allows continuous production of the food product, starting from production of the continuous food precursors. This also means that a storage unit for storing the continuous food precursors can be dispensed with. It also obviates the need for conveyors for conveying the continuous food precursors out of the production unit.

Pulling the first continuous food precursor and the second continuous food precursor in the conveying direction preferably also comprises, as a substep, unrolling the first continuous food precursor and/or the second continuous food precursor from at least one (first) storage device by applying a tractive force having at least one force component in the conveying direction, wherein the (first) storage device is adapted to receive the first continuous food precursor and/or the second continuous food precursor in a rolled-up state. The (first) storage device is adapted, in particular, to receive the first continuous food precursor and/or the second continuous food precursor in a winding pattern in the rolled-up state such that the axial orientation of the first continuous food precursor and/or the second continuous food precursor changes according to an unrolling angle. Unrolling the continuous food precursors from a storage device by applying a tractive force allows variation of the continuous food precursors being used and makes it possible to provide them independently of the production speeds of a production device. Such a storage device may be a spool, a rod, a tray, a roll or the like. The continuous food precursors can be received on such a storage device in oriented form, and the orientation of the first continuous food precursor relative to the second continuous food precursor can be influenced by their arrangement on the storage unit.

Pulling the first continuous food precursor and the second continuous food precursor in the conveying direction preferably also comprises, as a substep, unrolling the first continuous food precursor and/or the second continuous food precursor from at least one (second) storage device by applying a tractive force having at least one force component in the conveying direction, wherein the (second) storage device is adapted to receive the first continuous food precursor and/or the second continuous food precursor in a randomized state. By pultruding the continuous food precursors from a storage device in which they have been received in randomized form, it is possible in particular to provide robust continuous food precursors in a cost-efficient manner. For example, films, nonwovens and the like can be received in a randomized state in a tub or tun and pultruded in the conveying direction by a tractive force in the method according to the invention.

It is further preferred that the first continuous food precursor and/or the second continuous food precursor are conveyed for oriented arrangement in the conveying direction via a number of guide units. The guide units are adapted to deflect the first continuous food precursor and/or the second continuous food precursor orthogonally to the conveying direction such that the first continuous food precursor and/or the second continuous food precursor have a variable orientation relative to each other and orthogonally to the conveying direction along a longitudinal extension of the continuous strand extending coaxially with the conveying direction. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. It is possible, in particular, to vary spacings between the continuous food precursors relative to each other.

It is also preferred that an angle relative to the conveying direction and/or a position orthogonal to the conveying direction of a/the guide unit and/or a position in the conveying direction of a/the guide unit is controllable. The method preferably includes controlling the position and/or the angle of the guide units in such a way that the first continuous food precursor and/or the second continuous food precursor have a variable orientation relative to each other and orthogonally to the conveying direction along a longitudinal extension of the continuous strand. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. Variable positions and/or angles of the guide units can be easily realized and automated with control engineering.

Alternatively or additionally, the (first) storage device preferably has a number of storage units for receiving the first continuous food precursor and/or the second continuous food precursor. The position of the storage units orthogonal to the conveying direction and/or in the conveying direction is preferably controllable for oriented arrangement of the first continuous food precursor and/or the second continuous food precursor. The method includes controlling the position of the storage unit in such a way that the first continuous food precursor and/or the second continuous food precursor have a variable orientation relative to each other and orthogonally to the conveying direction along a longitudinal extension extending coaxially with the conveying direction. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. Variable positions of the storage units can be easily realized and automated with control engineering.

By controlling the position of the storage units and guide units orthogonally to the conveying direction and/or in the conveying direction, it is also possible to support the conveying and guiding of the first and second food precursors. Controlling the position of the storage units and guide units thus makes it possible, for example, to counteract any sagging of the first and second food precursors or to keep the unrolling angle of (other) storage devices constant.

Alternatively or additionally, the (first) storage device preferably has a number of storage units for receiving the first continuous food precursor and/or the second continuous food precursor, whose angle (α) relative to the conveying direction is controllable for oriented arrangement of the first continuous food precursor and/or the second continuous food precursor such that the first continuous food precursor and/or the second continuous food precursor have a variable orientation relative to each other and orthogonally to the conveying direction along a longitudinal extension. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. Variable angles of the storage units can be easily realized and automated with control engineering.

Alternatively or additionally, the (first) storage device, for oriented arrangement of the first continuous food precursor and/or the second continuous food precursor, preferably has a/the number of storage units for receiving the first continuous food precursor and/or the second continuous food precursor, wherein the storage units have a (first) longitudinal extension and a cross-section varying along the longitudinal extension such that the first continuous food precursor and/or the second continuous food precursor have a variable orientation relative to each other and orthogonally to the conveying direction along a longitudinal extension extending coaxially with the conveying direction. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. A varying cross-section of the storage units is constructionally easy to realize.

Alternatively or additionally, for oriented arrangement in the conveying direction, the first continuous food precursor and/or the second continuous food precursor are preferably conveyed via a number of guide units, the guide units having a (second) longitudinal extension and a varying cross-section along the longitudinal extension such that the first continuous food precursor and/or the second continuous food precursor have a variable orientation relative to each other and orthogonally to the conveying direction along a longitudinal extension extending coaxially with the conveying direction. Thus it is not only the orientation of the first continuous food precursor and/or the second continuous food precursor in relation to the product cross-section that can be varied in the method, but also the orientation of the first continuous food precursor relative to the second continuous food precursor along the longitudinal extension. This further increases the options for varying the topology of the food product. A varying cross-section of the guide units is constructionally easy to realize.

According to a preferred embodiment, the step of orientationally arranging the first continuous food precursor relative to the second continuous food precursor comprises at least one of the following substeps:
orientationally arranging a plurality of first continuous food precursors relative to one another to form at least one oriented first continuous substrand,
orientationally arranging a plurality of second continuous food precursors relative to one another to form at least one oriented second continuous substrand, and
orientationally arranging the at least one first continuous substrand relative to the at least one second continuous substrand and/or the second continuous food precursors,
orientationally arranging the at least one second substrand relative to the at least one first continuous substrand and/or the first continuous food precursors.

Single, multiple or all the substeps for orientationally arranging are preferably repeated and/or carried out in parallel until the oriented continuous strand has a cross-section whose surface area is equal to at least that of the cross-section of the food product to be produced. Thus, in addition to orienting the first continuous food precursors relative to the second continuous food precursors, it is also possible according to the method for a plurality of first continuous food precursors to be arranged relative to each other, thereby forming a first continuous substrand. Alternatively or additionally, it is also possible for a plurality of second continuous food precursors to be arranged and oriented relative to each other to form a second continuous substrand. The first and second continuous substrand can each be oriented then in relation to the other continuous substrands or to form a plurality of continuous substrands or individual first and second continuous food precursors. The substeps for orienting the continuous food precursors and the continuous substrands are carried out a corresponding number of times so that the resultant continuous strand has a sufficiently large cross-sectional area. This cross-sectional area must exceed the surface area of the cross-section of the food product to be produced in such a way that any shrinkage due to consolidation of the continuous strand is taken into account when forming a shaped article.

The method preferably also includes combining a number of continuous strands and conveying the continuous strands together in the direction of the shaping device. The combination of continuous strands can be either continuous strands produced by orientationally arranging first and second continuous food precursors, or continuous substrands each made of the first continuous food precursors or the second continuous food precursors. The combined number of continuous strands is preferably conveyed under the action of a tractive force in the conveying direction toward the shaping device. The orientation of the first continuous food precursors and second continuous food precursors is thus retained.

According to another preferred embodiment, the method also includes applying at least one auxiliary structure to at least one portion of the first continuous food precursor and/or the second continuous food precursor and/or the continuous strand.

The auxiliary structure preferably includes an auxiliary guiding structure designed to support the orientational arranging of the first continuous food precursor and/or the second continuous food precursor by arranging them in bundles within the auxiliary guiding structure. The auxiliary guiding structure is preferably removed prior to formation of the shaped article. This reduces or completely prevents any slippage or other unravelling of the orientational arrangement of the first continuous food precursor relative to the second continuous food precursor. Such auxiliary guide structures can be provided, in particular, in areas that are exposed to special stresses during the production process, for example the action of shearing forces.

It is further preferred that the auxiliary structure also includes an auxiliary conveying structure designed to support the pulling of the first continuous food precursor and/or the second continuous food precursor in the conveying direction and/or the conveying of the continuous strand in the direction of the shaping device by reducing peak stresses. The auxiliary conveying structure is preferably removed prior to formation of the shaped article. The auxiliary conveying structure can improve the transfer of forces and by reducing peak stresses can prevent damage to the first continuous food precursor and/or the second continuous food precursor. The delicate structure of the continuous food precursors is taken into account thereby and protected accordingly.

It is further preferred that the auxiliary structure includes a structural support designed to form a structure in the shaped article and/or to support structural formation of the shaped article when being shaped from the continuous strand or strand portion. The structural support preferably remains in the shaped article during shaping. Such a structural support may comprise, for example, an alginate casing that is intended to imitate defined structures in the food portion or in the shaped article.

The step of conveying the continuous strand in the direction of the shaping device preferably includes applying tractive forces in the conveying direction to the continuous strand and/or the shaped article. Applying tractive forces in the conveying direction to the continuous strand ensures that the continuous strand is conveyed straight in the direction of the downstream shaping device. The application of such tractive forces to the shaped article also allows the continuous strand to be drawn into the shaping device in the event that the shaped article is connected to the continuous strand.

Conveying the continuous strand in the direction of the shaping device preferably also includes applying shearing forces in the conveying direction to a surface of the first continuous food precursor and/or the second continuous food precursor and/or the continuous strand and/or the shaped article. Alternatively or additionally applying shearing forces reduced peak stresses caused by pulling. In particular, applying shearing forces also allows, for example, any sagging of the continuous food precursors due to gravity to be reduced. Applying shearing forces also promotes cohesion of the continuous food precursors individually or within the continuous strand. Thus, the application of shearing forces also prevents damage from occurring to the continuous precursors and takes their delicate structure into account. Such shearing forces can be applied by conveyor belts or by driven rolls, for example.

The step of conveying the continuous strand in the direction of the shaping device preferably also includes conveying the continuous strand in the conveying direction into the shaping device by means of at least one conveyor. In particular, such a conveyor is arranged in the conveying direction downstream from the shaping device in the event that the shaped article is connected to the continuous strand. In the event that the shaped article has already been separated from the continuous strand, the conveyor is adapted to convey the continuous strand into the shaping device.

The step of conveying the continuous strand in the direction of the shaping device preferably also includes conveying the continuous strand into the shaping device under the action of tractive forces. Conveying the continuous strand under traction into the shaping device also results in the continuous strand and the continuous food precursors being conveyed in the direction of the shaping device.

The step of conveying the continuous strand in the direction of the shaping device preferably also includes conveying the first continuous food precursor and/or the second continuous food precursor and/or the continuous strand using gravity. It is preferably here that an upstream part of a food production machine used to carry out the method according to the invention is arranged in a horizontally inclined position such that the continuous food precursors and the continuous strand are subjected to the force of gravity while being conveyed in the direction of the shaping device. The tension exerted by the necessary tractive forces on the continuous food precursors and the continuous strand can thus be reduced. At the same time, the force of gravity causes gentle stretching of the continuous food precursors and the strand.

The step of conveying the continuous strand in the direction of the shaping device preferably also includes subsequent conveying into the shaping device of a strand portion formed by cutting the continuous strand. The strand portion can thus be formed into a shaped article in the shaping device as part of a batch process.

The tractive forces are preferably applied to the continuous strand and/or the first continuous food precursor and the second continuous food precursor using a/the conveyor. The conveyor preferably includes at least one conveyor unit designed as a traction unit for applying tractive forces having at least one force component in the conveying direction to the continuous food precursors and/or the continuous strand and/or the shaped article. By means of a traction unit, tractive forces can be applied purposefully, preferably in a controlled manner. Alternatively or additionally, the conveyor includes at least one conveyor unit for applying shearing forces to the first continuous food precursor and/or the second continuous food precursor and/or the continuous strand and/or the shaped article. By applying shearing forces, such a conveyor unit reduced any peak stresses and can counteract any sagging of the continuous strand or the continuous food precursors as a result of gravity. The conveyor unit preferably also includes a multiple belt, in particular a double belt, the double belt preferably being integrated in a pressing tool as the shaping device. In conjunction with the shaping device, the conveyor unit forms a double-belt press, i.e., a continuous shaping tool. It is preferable that the traction unit also includes a winding device and/or a suction device and/or a gripping device.

According to another preferred embodiment, the method comprises processing the first continuous food precursor and/or the second continuous food precursor in at least one continuous precursor processor. The first continuous food precursor and/or the second continuous food precursor preferably run through different continuous precursor processing units. This means that processing, for example in the form of texturising, drying or surface coating or surface finishing, can already be carried out on the continuous food precursor. At that stage, processing is more exact, because the continuous food precursors are still separately present. The possibility of processing the first continuous food precursors and the second continuous food precursors individually allows a greater variety of producible variants to be produced, and different characteristics of the first and second continuous food precursors being used can be achieved additionally in the food product. It is also envisaged that a proportion of the first continuous food precursors passes through a first continuous precursor processor, while a second portion of the first continuous food precursors passes through a second continuous precursor processor that is different from the first continuous precursor processor. It is thus possible with just one basic continuous precursor to produce wide-ranging variants of the continuous precursors being used, and to achieve a tailor-made topology of the food product.

Alternatively or additionally, the method includes processing the continuous strand and/or the strand portion in at least one strand processor. Processing the strand can be carried out in order to obtain particular surface properties, for example. Uniform processing of the continuous strand and/or the strand portion can also be carried out in only one strand processor, so that the number of processors can be reduced compared to various different precursor processors. Such a strand processor can be configured, for example, to carry out additive techniques for treating the surface of the continuous strand. A spraying device can be provided, for example, by means of which the strand is sprayed with a fluid. Excess fluid is then collected preferably in a collecting tank and recycled for reuse by the spraying device. Such a fluid can be fat, food coloring or a binding agent.

Alternatively or additionally, the method further comprises processing the food product in at least one food product processor. Properties for the food products can thus be adjusted portion-wise. This may include infusion of the food product with fat, water or other ingredients, for example. Surface treatment of the food product, for example by applying films, is also possible to a highly individual degree.

Alternatively or additionally, the method comprises processing the shaped article in at least one shaped article processor. Processing of the shaped article may include cyclic surface treatment, for example. Such cyclic surface treatment creates an irregular surface with a defined profile of characteristics. Compared to processing the food product, processing the shaped article also has the advantage that production-related spacings between the food product and the like in a continuous shaped article play no role prior to them being separated.

The continuous precursor processor preferably includes at least one of the following continuous precursor processing units:
a twisting unit, wherein the method comprises twisting the first continuous food precursor and/or the second continuous food precursor in the twisting unit,
a stretching unit, wherein the method comprises stretching the first continuous food precursor and/or the second continuous food precursor in the twisting unit,
an extending unit, wherein the method comprises extending the first continuous food precursor and/or the second continuous food precursor in the extending unit,
a conditioning unit, wherein the method comprises conditioning the first continuous food precursor and/or the second continuous food precursor in the twisting unit,
a tempering unit, wherein the method comprises cooling or heating the first continuous food precursor and/or the second continuous food precursor in the tempering unit,
a drying unit, wherein the method comprises drying the first continuous food precursor and/or the second continuous food precursor in the drying unit,
a texturising unit, wherein the method comprises texturising the first continuous food precursor and/or the second continuous food precursor in the texturising unit,
a wetting unit, wherein the method comprises wetting the first continuous food precursor and/or the second continuous food precursor with a binding agent and/or a dye and/or a sizing agent in the wetting unit,
a vapor coating unit, wherein the method comprises vapor coating the first continuous food precursor and/or the second continuous food precursor with fluids, in particular containing water, and/or with flavoring and/or dye in the vapor coating unit,
a powder coating unit, wherein the method comprises powder coating the first continuous food precursor and/or the second continuous food precursor with a functional powder in the powder coating unit,
a squeezing unit, wherein the method comprises squeezing the first continuous food precursor and/or the second continuous food precursor in order to release excess binding agent and/or crosslinking agent in the squeezing unit.

Texturising is understood to mean the mechanical post-processing of continuous food precursors containing filaments or multifilaments or other fiber materials, in order to obtain characteristics such as increased volume, roughness, elastic extension, better thermal insulation (by means of air entrapments), better moisture absorption, etc. For example, false wire texturising or stuffer box texturising can be carried out to increase the roughness of the surface.

Conditioning is understood here to mean any work processes that are used to modify continuous food precursors containing filaments or multifilaments or other fiber materials, by advantageously designing their external characteristics, for example by dyeing them.

Stretching is understood here to mean stretching continuous food precursors containing filaments or multifilaments or other fiber materials to a multiple of their length, whereby the filaments or multifilaments or other fiber materials retain their essential characteristics. Stretching is carried out, for example, by using a very high speed when pultruding from a spinning nozzle of a production device, for example, or by guiding the continuous food precursor over several rolls of different sizes, or by applying a rotation. Stretching aligns molecule chains of the food precursor with their longitudinal axis, which extends parallel to the conveying direction in sections at least, and can result in interactions between the chains (hydrogen bond compounds). Stretching thus increases the firmness of the continuous food precursors significantly. Extending the continuous precursors differs from stretching in that it is not aimed at the alignment of molecule chains, but at plastic or elastic deformation. For example, elastic extension can be produced in an extender unit, so that processing by means of other processor units, for example a powder coating unit, is simplified.

By means of the coating unit, it is possible, for example, to add solid additives to continuous food precursors and/or continuous (sub)strands, for example as short fibers, by spreading and/or coating.

Twisting is understood here to mean performing a relative movement comprising a rotation of continuous food precursors and/or continuous (sub)strands in relation to each other or about a central axis.

It is further preferred that the strand processor includes at least one of the following strand processing units:
a tempering unit, wherein the method comprises cooling or heating the continuous strand in the tempering unit,
a drying unit, wherein the method comprises drying the continuous strand,
a texturising unit, wherein the method comprises texturising the continuous strand,
a powder coating unit, wherein the method comprises powder coating the continuous strand with a functional powder,
a squeezing unit, wherein the method comprises squeezing the continuous strand in order to release excess binding agent and/or crosslinking agent,
an infusing unit, wherein the method comprises infusing the continuous strand with fluids, in particular containing water, and/or with fat and/or binding agents and/or an enzymatic solution,

A squeezing unit is used to remove excess fluid, for example binding agent. A texturising unit is used to texturize the products, for example by surface treatment. A drying unit is used, for example, to reduce the residual moisture in the precursors or to dry the latter after soaking, vaporizing, spraying or the like.

It is further preferred that the shaped article processor includes at least one of the following shaped article processing units:
an infusing unit, wherein the method comprises infusing the shaped article with fluids, in particular containing water, and/or with fat and/or binding agents and/or an enzymatic solution and/or imitation blood,
a coating unit, wherein the method comprises coating the shaped article with at least one functional surface coating. Such a functional surface coating can produce browning during roasting, for example.

It is further preferred that the food product processor includes at least one of the following food product processing units:
an infusing unit, wherein the method comprises infusing the food product with fluids, in particular containing water, and/or with fat and/or flavoring and/or dye and/or hydrocolloids and/or proteins and/or polysaccharides and/or an enzymatic solution,
a coating unit, wherein the method comprises coating the food product with at least one functional surface coating,
   wherein the first continuous food precursor and the second continuous food precursor preferably run through different continuous precursor processing units.

Other fluids that may be suitable for infusion are alcohols, acids and bases.

According to a preferred embodiment, the method further comprises packaging the food product in vacuum-tight packaging and vacuuming the vacuum-tight packaging. By vacuuming the vacuum-tight packaging, the food product is packaged reliably and the shelf life is extended by excluding air and other gases.

Alternatively or additionally, the method comprises heating the food product to a crosslinking temperature and keeping the crosslinking temperature constant for a crosslinking duration. If enzymatic binding agents or stuffing masses are used during processing of the continuous food precursors and the continuous strand, these may react enzymatically due to being heated to a crosslinking temperature, resulting in crosslinking and thus the creation of cohesion within the food product. Crosslinking generally takes so long that crosslinking cannot be carried out in the method before the shaped article is formed. Heating the food product inside the packaging also provides the advantages that heating can be a downstream process, for example passing through a conveyor-type oven, or heating a number of packaged food products in a batch process.

It is further preferred that the food product is a food product close to its final shape and that vacuuming is carried out in such a way that the vacuum-tight packaging defines a final shape of the food product and the food product close to its final shape adopts its final shape in the vacuum-tight packaging by vacuuming. The food product thus receives its final shaping by vacuuming. Vacuuming in a defined casing is a standard procedure known from textile engineering and which is used her to produce a food product portion.

The method preferably also includes crosslinking the food product by means of a crosslinking agent. Such crosslinking may be thermally induced, or may be carried out at room temperature and completed after a crosslinking duration has elapsed.

According to another preferred embodiment, the method comprises heating the surface of the continuous strand and/or the strand portion in the shaping device above a cauterization temperature in such a way that enzymatic and/or chemical crosslinking close to the surface is prevented. The cohesion in the shaped article that has been formed is thus fostered by preventing any chemical or enzymatic crosslinking. This involves cauterizing the surface, as a result of which is has a texture that differs from the rest of the shaped article.

According to another preferred embodiment, the method comprises freezing the surface of the continuous strand and/or the strand portion in such a way that enzymatic and/or chemical crosslinking close to the surface is prevented. The cohesion in the shaped article that has been formed is thus fostered by preventing any chemical or enzymatic crosslinking. This involves cauterizing the surface, as a result of which is has a texture that differs from the rest of the shaped article.

According to another preferred embodiment, the method further comprises the step of providing a raw food mass containing at least one plant-based protein and/or fat, in particular, and shaping the raw food mass into a first continuous food precursor and/or a second continuous food precursor. The step of shaping the raw food mass into the respective continuous food precursors preferably comprises at least one of the following methods: a yarn-forming technique and/or a nonwoven laying technique using mycelium, dry extrusion, high moisture extrusion, a spinning process, microextrusion, a textile surface formation process, in particular a solidification technique for producing nonwoven materials or for producing fiber strips, a shear chamber technique or a depositing technique, also and in particular in 3D printing. It should be understood here that shaping the raw food mass into the respective continuous food precursors may also comprise a combination of several of these methods and techniques. It should be understood that, according to the invention, the aforementioned methods and techniques can also be used just to produce preliminary precursors for the actual production of the continuous food precursors. In the shear chamber technique, for example, and also in the depositing technique, which is also referred to as 3D printing in some cases, continuous food precursors cannot be produced, but it is possible to produce a modified raw mass, for example one provided with fibers, which can be converted into a continuous food precursor in further processing steps.

The first continuous food precursor and/or the second continuous food precursor preferably comprise a filament and/or a multifilament and/or a fiber strip and/or a fiber, in particular a staple fiber, and/or a fiber bundle and/or a fiber strand. Using continuous textile precursors allows the texture of meat to be well mimicked. Fiber bands and fiber bundles, but also fibers, in particular staple fibers, allows easier handling compared to filaments or multifilaments. It is further preferred that the first continuous food precursor and/or the second continuous food precursor comprises a polymer film made of raw food mass. However, such a film can also be used to form meat-like structures and can be provided in continuous form. It is further preferred that the first continuous food precursor differs from the second continuous food precursor. Providing the continuous food precursors thus ensures that different material properties of the food product are provided They can be fat fibers and protein fibers, for example.

Fibers in the context of the invention are structures whose lengths are significantly greater than their cross-section. Fibers normally have a finite length.

In the context of the invention, fibers normally have a structure-forming component consisting of proteins and/or polysaccharides (e.g. cellulose or starch) and/or fats and/or dietary fibers.

Fibers may consist of structured proteins. In the case of plant-based proteins, these may be structured beforehand by a structuration process, such as an extrusion process, in particular a spinning process (electrospinning, wet spinning or dry spinning), or an additive production process. Filaments refer to continuous fibers.

Multifilaments are composites of fibers in the form of a yarn or similar, which are produced as cohesive materials in a spinning process. They are also characterized in their length being many time greater than their diameter. In most cases, a plurality of spinning nozzle apertures are used. The individual filaments pultruded together as a bundle are then referred to as a multifilament and are supplied for further textile processing.

In a second aspect, the invention achieves the object initially specified with a method according to claim 28 of producing a continuous food precursor for producing a food product, in particular a meat substitute product, in particular for use in a method according to the first aspect of the invention. According to the second aspect, the invention proposes that the method comprises the following steps:
pulling at least a first preliminary food precursor and/or a second preliminary food precursor in a conveying direction,
orientationally arranging the first preliminary food precursor under traction relative to the second preliminary food precursor under traction and orthogonally to the conveying direction in order to form a continuous oriented food precursor. The first preliminary food precursor and/or the second preliminary food precursor preferably comprise a filament and/or a multifilament and/or a fiber and/or a yarn, the preliminary food precursor being a fiber strip, a fiber bundle or a fiber strand. It should be understood that the steps of the method carried out with respect to the first continuous food precursor and the second continuous food precursor can preferably also be carried out accordingly with the first preliminary food precursor and the second preliminary food precursor.

Preferred embodiments according to the first aspect of the invention, in particular embodiments relating to the pulling and orientationally arranging, and also any processing steps in processing units, and to conveying, are also preferred embodiments with respect to the second aspect of the invention. By orientationally arranging the first preliminary food precursor relative to the second preliminary food precursor and orthogonally to the conveying direction and by pulling the preliminary food precursors in such a way that the step of orientationally arranging is carried out under traction, the method according to the second aspect of the invention utilizes the advantages mentioned above with reference to the first aspect of the invention.

According to a preferred embodiment, the method comprises the step of applying at least one auxiliary structure to at least one portion of the first preliminary food precursor and/or the second preliminary food precursor. The auxiliary structure preferably includes an auxiliary guiding structure designed to support the orientational arranging of the first preliminary food precursor and/or the second preliminary food precursor by arranging them in bundles within the auxiliary guiding structure. It is further preferred that the auxiliary structure includes an auxiliary conveying structure designed to support the pulling of the first preliminary food precursor and/or the second preliminary food precursor in the conveying direction and/or to reduce peak stresses. The auxiliary structure preferably also includes a structural support designed to form a structure in a continuous food precursor produced from the first food precursor and/or the second food precursor.

The method according to the second aspect of the invention is also a preferred step of the method according to the first aspect of the invention.

In a third aspect, the invention achieves the object specified above by means of a control method for controlling an oriented arrangement of continuous food precursors for producing a food product, in particular a meat substitute product, according to claim 30. According to the third aspect, the invention proposes that the control method comprises the steps of:
defining a first position in at least one direction orthogonal to a conveying direction of a first continuous food precursor and/or of a second continuous food precursor in relation to at least a second position of the first continuous food precursor and the second continuous food precursor in the conveying direction and/or defining an angle of the first continuous food precursor and/or the second continuous food precursor relative to a conveying direction of a first continuous food precursor and a second continuous food precursor,
defining a conveying speed of the first continuous food precursor and/or the second continuous food precursor in the conveying direction,
changing the first position and/or the angle in a time-controlled manner depending on the conveying speed, in such a way that the first continuous food precursor and/or the second continuous food precursor have a variable orientation relative to each other and orthogonally to the conveying direction along a longitudinal extension of the continuous strand extending coaxially with the conveying direction.

Such a control method also allows stretching and/or extending of the continuous food precursors to be controlled and to be integrated into the method.

The control method according to the third aspect of the invention is preferably also a preferred step in the method for producing a food product according to the first aspect of the invention, and a preferred step in the method for producing continuous food precursors according to the second aspect of the invention.

By making the orientational arranging of the continuous food precursors and the preliminary precursors controllable, and by making it possible to vary this orientation along the longitudinal extension of the continuous strand to be formed by the continuous food precursors, the control method utilizes the advantages described above with reference to the first aspect of the invention and the second aspect of the invention. Being able to control the orientational arranging of the first continuous food precursor relative to the second continuous food precursor allows meat-like structures to be mimicked, with the texture of the continuous food precursors being retained in the continuous strand. The distribution of the respective continuous food precursor in the continuous strand can thus be controlled in a targeted manner, and characteristics of the continuous strand and a food product produced from it can be influenced in a targeted manner. The water absorption capacity, for example, can be increased by finely distributing the continuous food precursors and by forming finely distributed cavities to match.

Preferred embodiments relating to the orientational arranging according to the first aspect of the invention and the second aspect of the invention are also preferred embodiments of the control method according to the third aspect of the invention. The control method is also designed to control a food production machine according to the fifth aspect of the invention.

In a fourth aspect according to claim 31, the invention achieves the object specified above by means of a food product, in particular a meat substitute product.

According to the fourth aspect, the invention proposes that the food product is produced in a method according to the first aspect of the invention. Alternatively or additionally, the invention proposes, according to the fourth aspect, that the food product comprises a number of first continuous food precursors and a number of second continuous food precursors that are arranged relative to each other orthogonally to a longitudinal extension of the food product, wherein the first continuous food precursors and/or the second continuous food precursors have anisotropic material properties, and that at least a proportion of the first continuous food precursors and/or the second continuous food precursors extend along the entire longitudinal extension. It should be understood here that the first continuous food precursors and/or the second continuous food precursors do not have to be oriented in the direction of the longitudinal extension. According to the invention, at least a proportion of the first continuous food precursors and/or the second continuous food precursors run end-to-end from one end face of the food product to a second end face of the food product spaced apart in the direction of the longitudinal extension.

By orientationally arranging the first continuous food precursors relative to the second continuous food precursors in the respective manner, the food product according to the fourth aspect of the invention utilizes the advantages described above with reference to the first to third aspects of the invention. Preferred embodiments described with reference to the first to third aspects of the invention are also preferred embodiments according to the fourth aspect of the invention, and vice versa.

It is preferred that at least a proportion of the first continuous food precursors and/or the second continuous food precursors are stretched at least in sections along the longitudinal extension of the food product. By stretching the continuous food precursors appropriately, the firmness inside the food product is increased locally. In this way, an area of greater firmness with a more meat-like structure can be locally provided. Such stretching also allows exact positioning of the first continuous food precursors and the second continuous food precursors within the food product. In such a case, a continuous strand or strand portion is conveyed under traction, in sections at least, to the shaping device in order to produce the food product, and the tractive force is maintained within the continuous strand or strand portion.

In a fifth aspect according to claim 33, the invention achieves the object specified above with a food production machine for producing a food product, in particular a meat substitute product. According to the fifth aspect, the invention proposes that the food production machine is designed to carry out a method according to the first aspect of the invention. The invention according to the fifth aspect also proposes that the food production machine comprises:
a conveyor adapted to pull at least a first continuous food precursor and a second continuous food precursor in a conveying direction,
a storage device and/or a conveyor device, each adapted to store and/or orientationally arrange the first continuous food precursor relative to the second continuous food precursor and orthogonally to the conveying direction to form a continuous oriented strand,
a shaping device adapted to apply compressive forces having at least one compressive force component orthogonal to the conveying direction to form a shaped article that in plane E is at least close to its final shape, and
a cutting device adapted to cut the continuous strand into a strand portion, and the shaped article connected to the continuous strand into a food product, wherein the conveyor is further adapted to convey the continuous strand in the direction of the shaping device under the action of tractive forces having at least one force component in the conveying direction, and preferably
a dispensing unit for dispensing the shaped article and the food product from the shaping device.

The food production machine utilizes the advantages described above with reference to the first aspect of the invention. Advantages and preferred embodiments according to the first to fourth aspects of the invention are also preferred embodiments and advantages of the food production machine according to the fifth aspect of the invention, and vice versa.

It is further preferred that at least one conveyor unit of the conveyor is arranged downstream from the shaping device in the conveying direction. By means of an appropriately arranged conveyor unit, the continuous strand or a strand portion can be conveyed into the shaping device in a simple manner.

Embodiments of the invention shall now be described with reference to the drawings. These are not necessarily meant to show the embodiments true to scale; rather, the drawings are provided in schematic and/or slightly distorted form wherever this is helpful for the description. Further advantages, features and details of the invention are shown in the following description of the preferred embodiments and with reference to the drawings, in which

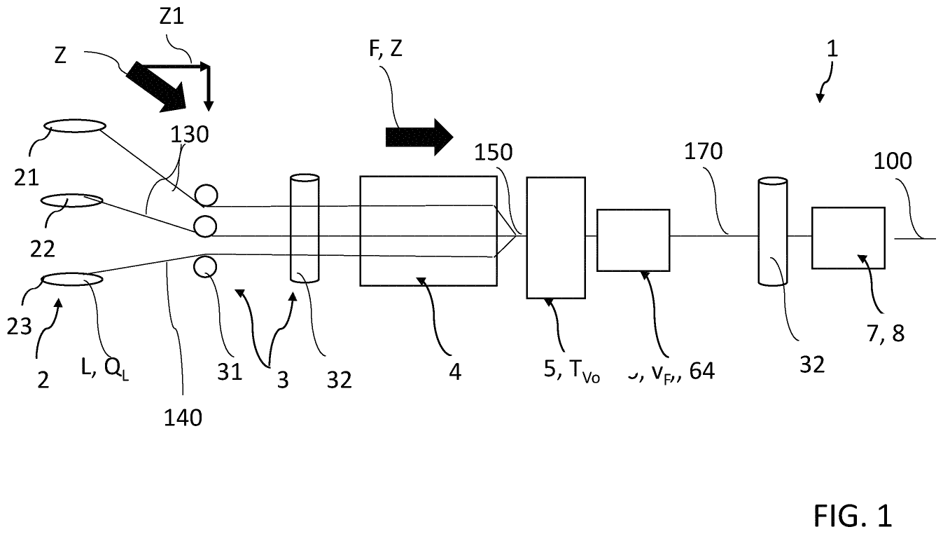

FIG. 1 shows a schematic top view of a food production machine;

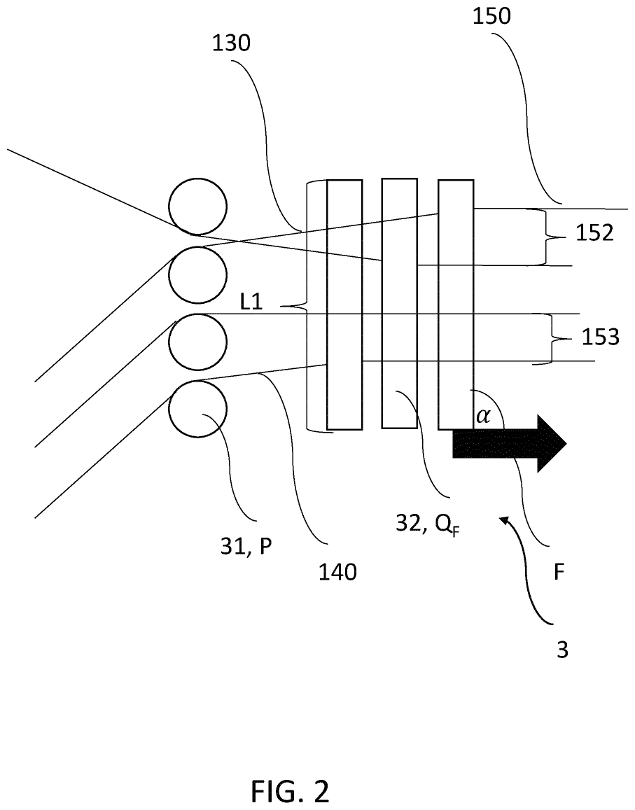

FIG. 2 shows a guiding mechanism for a food production machine as shown in FIG. 1;

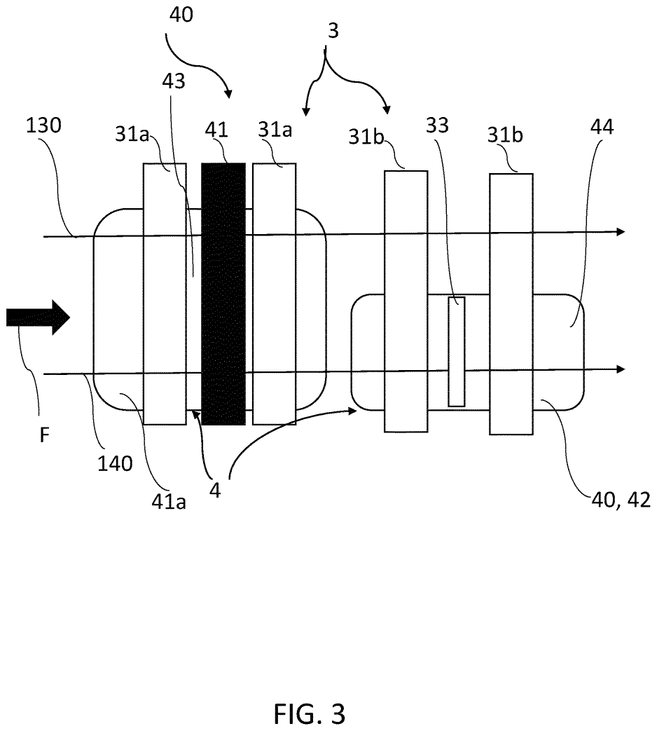

FIG. 3 shows a guide mechanism and a processor for a food production machine as shown in FIG. 1;

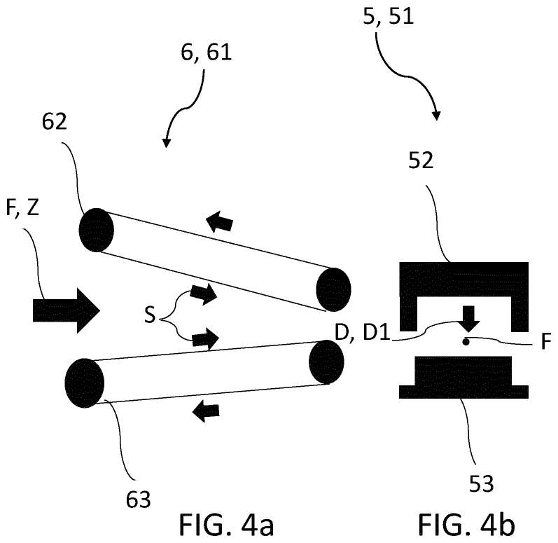

FIG. 4 shows a shaping device and a conveyor for a food production machine as shown in FIG. 1;

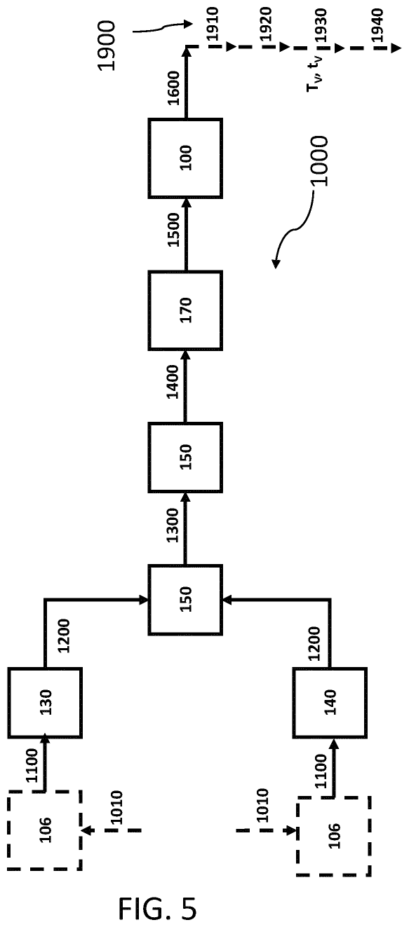

FIG. 5 shows a method for producing a food product according to a first embodiment;

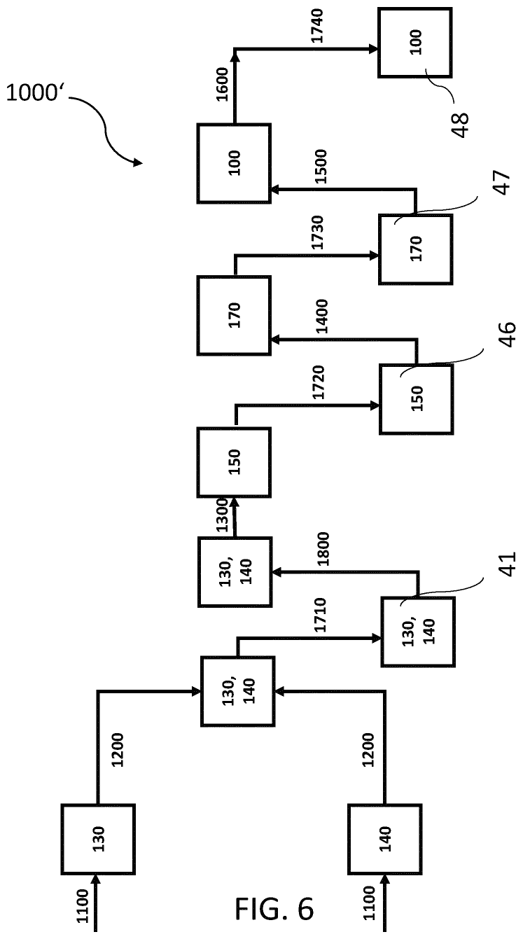

FIG. 6 shows a method for producing a food product according to a second embodiment;

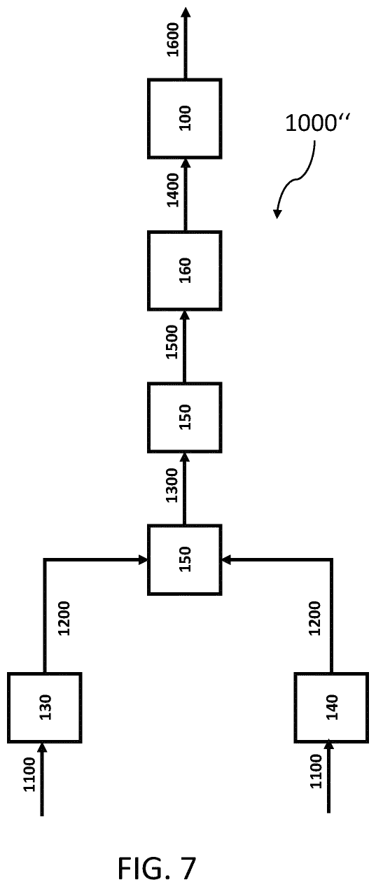

FIG. 7 shows a method for producing a food product according to a third embodiment;

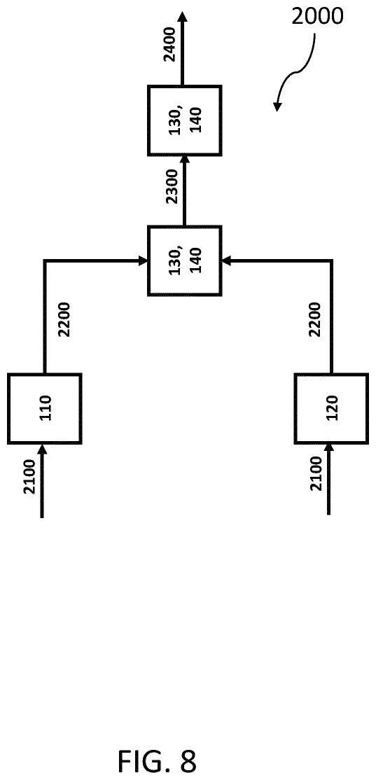

FIG. 8 shows a method for producing a continuous food precursor for a method as shown in FIGS. 5 to 7;

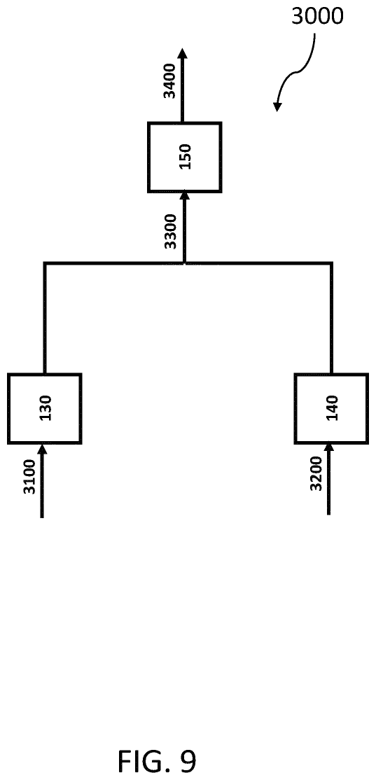

FIG. 9 shows a control method for orientationally arranging continuous food precursors for a method as shown in FIGS. 5 to 7;

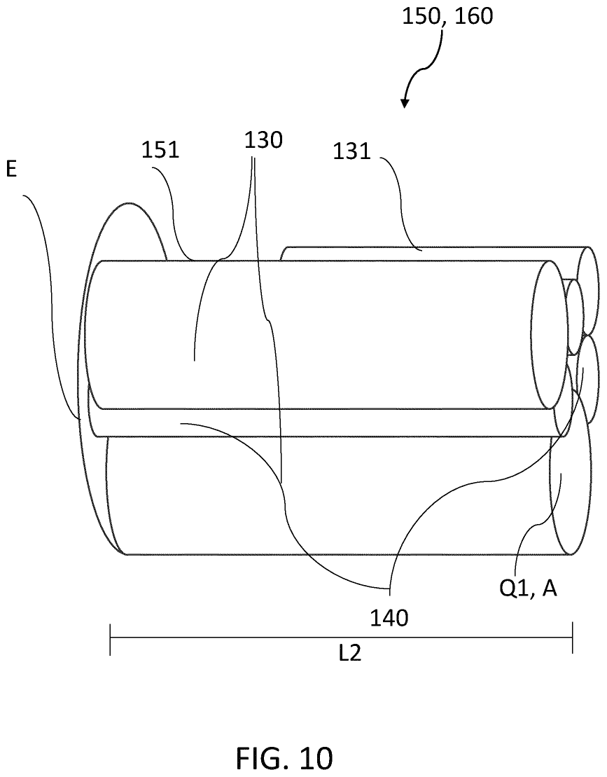

FIG. 10 shows a side view of a continuous strand or strand portion;

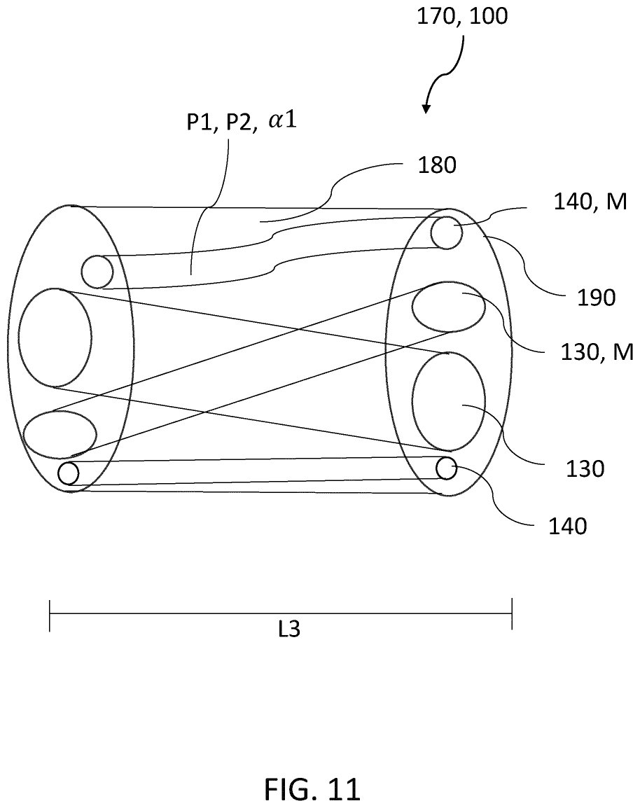

FIG. 11 shows a side view of a food product; and

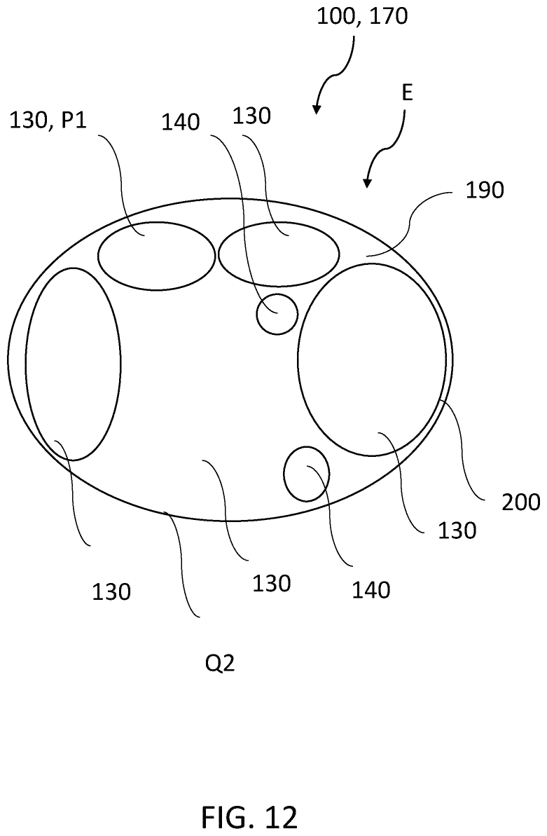

FIG. 12 shows a cross-sectional view of a food product.

FIG. 1 shows a food production machine 1 comprising a storage device 2 for receiving a number of first continuous food precursors 130 and second continuous food precursors 140 and having a guide mechanism 3 for guiding the first and second continuous food precursors 130, 140 in conveying direction F.

Food production machine 1 preferably also comprises a processor 4 which in the embodiment shown is arranged upstream in the conveying direction F from a shaping device 5 of food production machine 1. Shaping device 5 is adapted to apply compressive forces D having at least one compressive force component D1 (cf. FIG. 4b) orthogonal to conveying direction F in order to form a shaped article 170. In a sectional plane E orthogonal to the conveying direction F (cf. FIG. 12), shaped article 170 is preferably shaped at least close to its final shape.

Food production machine 1 also comprises a conveyor 6 which is adapted to pull at least the first and second continuous food precursors 130, 140 in conveying direction F. In the embodiment shown, conveyor 6 comprises a conveyor unit 64 arranged downstream from shaping device 5 in conveying direction F. However, conveyor 6 or individual conveyor units may also be arranged, alternatively or additionally, upstream from shaping device 5 in conveying direction F. A tractive force Z having at least one force component Z1 in conveying direction F is applied by conveyor 6 to the first continuous food precursor 130 and the second continuous food precursor 140.

Food production machine 1 further comprises a cutting device 7 and preferably a dispensing device 8. Dispensing device 8 may preferably also be integrated in cutting device 7. Cutting device 7 and/or dispensing device 8 may also be integrated in shaping device 5.

Conveying direction F describes the direction in which the first continuous food precursor 130 and the second continuous food precursor 140 are conveyed on their way from guide mechanism 3 to dispensing device 8. The movement of the first and second continuous food precursors 130, 140 does not have to be in a straight line in conveying direction F, but may be varied by guide mechanism 3, for example.

Storage device 2 preferably has a number of storage units 21, 22, 23 having a longitudinal extension L. Storage units 21, 22, 23 preferably have a cross-section Q_{L} orthogonal to the conveying direction. The orientation and arrangement of continuous food precursors 130, 140 can be controlled by varying cross-section Q_{L}.

Shaping device 5 can preferably also be adapted to heat a surface 151 (cf. FIG. 10) of continuous strand 150 or shaped article 170 to a cauterization temperature T_{Vo}.

Guide mechanism 3 is shown in detail in FIG. 2 and comprises a number of guide units 31, 32. In the view shown, first guide units 31 are vertically arranged in such a way that the first continuous food precursor 130 and the second continuous food precursor 140 are aligned in the horizontal direction orthogonal to conveying direction F via first guide units 31. Guide mechanism 3 further comprises a number of second guide units 32, which in the view shown are horizontally aligned and adapted to align and orientationally arrange the first continuous food precursor 130 and the second continuous food precursor 140 in the vertical direction orthogonal to conveying direction F. It should be understood here that the position and/or the angle of guide units 31, 32 are preferably controllable. Instead of a constant cross-section Q_{F}, guide units 31, 32 may also have a varying cross-section Q_{F} along a longitudinal extension L1 of guide units 31, 32, such that the first and/or second continuous food precursor 130, 140 are given an orientation or controlled guidance corresponding to the shape of the respective guide unit. As can be seen from FIG. 2 in particular, the angle α of the second guide units relative to conveying direction F can preferably be varied, or the position P of the first guide units 31 can be varied in conveying direction F and/or orthogonally to conveying direction F. Such control is preferably carried out in a method as shown in FIG. 9.

Such a guide mechanism 3 can also be used to orientationally arrange at least a first continuous substrand 152 relative to at least a second continuous substrand 153. The first continuous substrand 152 is preferably formed by a number of first food precursors 130, and the second continuous substrand 153 is preferably formed by a number of second food precursors 140.

FIG. 3 shows in detail another embodiment of guide mechanism 3 and a processor 4 for the food production machine shown in FIG. 1.

Guide mechanism 3 has first and second guide units 31, 32 as in the embodiment shown in FIG. 2. In addition, guide mechanism 3 has third guide units 33 which in the view shown are adapted to guide the first and second continuous food precursors 130, 140 in the vertical direction orthogonally to conveying direction F. Third guide units 33 are arranged here spaced apart in the vertical direction from first guide units 31.

Here, processor 4 comprises a precursor processor 40 comprising a number of continuous precursor processing units 41, 42, wherein a first continuous precursor processing unit 41 in the form of a spraying device is provided. The first continuous precursor processing unit 41 further comprises a collecting tank 41a adapted to collect media 43, in this case a first fluid medium 43, applied by the first continuous precursor processing unit 41 to the first and second continuous food precursors 130, 140. The first and second continuous food precursors 130, 140 are guided in the area of the first continuous precursor processing unit 41 by a first number of first guide units 31a.

Processor 4 further comprises a second continuous precursor processing unit 42 comprising a soaking tank in which a second fluid medium 44 is received. Guide mechanism 3 includes a second number of first guide units 31b configured to co-operate in such a way with a third guide unit 33 that the first and second continuous food precursors 130, 140 are guided in the vertical direction between the second number of first guide units and third guide unit 33 in such a way that they pass through the soaking tank of the second continuous precursor processing unit 42.

FIG. 4 shows by way of example an embodiment of a shaping device 5 and a conveyor 6. Shaping device 5 comprises a double-belt press 51. Double-belt press 51 is configured to apply a compressive force D, having at least one compressive force component D1 orthogonal to conveying direction F, to continuous strand 150 (cf. FIG. 1) or a strand portion 160 (cf. FIG. 7). Such a double-belt press 51 is a continuous shaping tool 51.

In this case, conveyor 6 comprises a conveyor unit 61 designed as a double belt. It should be understood here that the double belt is preferably integrated in double-belt press 51 and thus in the shaping tool 5 shown in FIG. 4b. Double belt 61 is adapted to convey continuous strand 150 (cf. FIG. 1) in conveying direction F. In FIG. 4b, double belt 61 conveys continuous strand 150 into the image plane. To do so, double belt 61 preferably has a first conveyor belt 62 and a second conveyor belt 63 that are adapted to apply shearing forces S to continuous strand 150. The first and the second conveyor belt 62, 63 converge progressively in conveying direction F, so that peak stresses in shaping device 5 resulting from the forces Z acting on continuous strand 150 are reduced or even completely prevented.

FIG. 5 shows a method 1000 for producing a food product 100. In a first step 1100, method 1000 comprises pulling at least a first continuous food precursor 130 and a second continuous food precursor 140 in conveying direction F (cf. FIG. 1). In a second step 1200, method 1000 comprises orientationally arranging the first continuous food precursor 130 pulled in conveying direction F relative to the second continuous food precursor 140 pulled in the conveying direction and orthogonally to conveying direction F to form a continuous oriented strand 150. In a third step 1300, the method comprises conveying continuous strand 150 in the direction of a shaping device 5 (cf. FIG. 1), wherein the direction is the same as conveying direction F. The conveying step is carried out under the action of tractive forces Z in conveying direction F (cf. FIG. 1).

In a fourth step 1400, method 1000 comprises forming the shaped article 170 by means of shaping device 5, by applying compressive forces D having at least one compressive force component D1 (cf. FIG. 4b) orthogonal to conveying direction F (cf. FIG. 1).

In a fifth step 1500, method 1000 comprises cutting the shaped article 170 connected to continuous strand 150 into a food product 100. In a sixth step 1600, the method preferably also comprises dispensing this food product 100 from shaping device 5.

The step of pulling in step 1100 preferably also comprises pultruding the first continuous food precursor 130 and/or the second continuous food precursor 140 from a production device (not shown) by applying tractive force Z having at least one force component Z1 in conveying direction F.

Alternatively, the step of pulling in step 1100 preferably also comprises unrolling the first continuous food precursor and/or the second continuous food precursor from at least one storage device 2 by applying a tractive force having at least one force component in conveying direction F, wherein the storage device is adapted to receive the first continuous food precursor and/or the second continuous food precursor in a rolled-up state, storage device 2 being adapted in particular to receive the first continuous food precursor and/or the second continuous food precursor in a winding pattern in the rolled-up state such that the axial orientation of the first continuous food precursor and/or the second continuous food precursor changes according to an unrolling angle.

Alternatively, the step of pulling in step 1100 preferably also comprises pultruding the first continuous food precursor and/or the second continuous food precursor from at least one second storage device by applying tractive force Z having at least one force component Z1 in conveying direction F. In such a second storage device (not shown), the first continuous food precursor and/or the second continuous food precursor can be received in a randomized state. The second storage device may be a tub, for example.

Method 1000 preferably comprises, as an upstream step 1010, providing a raw food mass 106 and shaping the raw food mass into a first continuous food precursor 130 and/or a second continuous food precursor 140. Step 1010 may preferably comprise one or more of the following methods: dry extrusion, high moisture extrusion, a spinning process, microextrusion, a textile surface formation process, in particular a solidification technique for producing nonwoven materials or for producing fiber strips, a shear chamber technique, a depositing technique, also and particularly in 3D printing.

It is further preferred that the method preferably comprises, as a downstream step 1900, packaging 1910 food product 100 in vacuum-tight packaging (not shown), preferably vacuuming 1920 the vacuum-tight packaging, and/or heating 1930 food product 100 to a crosslinking temperature T_{V} and keeping the crosslinking temperature for a crosslinking duration t_{V}, and/or crosslinking 1940 food product 100 with a crosslinking agent.

FIG. 6 shows a second embodiment of the method according to the invention 1000′ for producing a food product 100 (cf. FIG. 12). To avoid repetitions, only differences from the method according to FIG. 5 are discussed, and reference is made to the above description of that method.

Method 1000′ according to the second embodiment differs from method 1000 according to the first embodiment in that method 1000′ comprises processing continuous food precursors 130, 140 in a continuous precursor processing unit 41 in step 1710 before, after or parallel to orientationally arranging the first and second continuous food precursors 130, 140 in step 1200.

Alternatively or additionally, method 1000′ according to the second embodiment differs from method 1000 according to the first embodiment in that method 1000′ comprises processing the continuous strand in a strand processing unit in step 1720 before forming shaped article 170 in step 1400.

Alternatively or additionally, method 1000′ according to the second embodiment differs from method 1000 according to the first embodiment in that method 1000′ comprises processing shaped article 170 in a shaped article processing unit in step 1730 after or parallel to forming shaped article 170 in step 1400.

Alternatively or additionally, method 1000′ according to the second embodiment differs from method 1000 according to the first embodiment in that method 1000′ comprises processing food product 100 in a food product processing unit in step 1740 after the step of cutting in step 1500.

Alternatively or additionally, method 1000′ preferably comprises processing continuous strand 150 in a strand processing unit 46 of processor 4 following or parallel to the step of conveying continuous strand 150 in the direction of a shaping device 5 in step 1300. Alternatively or additionally, method 1000′ preferably also comprises processing shaped article 170 in a shaped article processing unit 47 of processor 4 after the step of forming the shaped article in step 1400. Alternatively or additionally, method 1000′ preferably also comprises processing food product 100 in a food product processing unit 48 after the step of cutting shaped article 170 from continuous strand 150 in step 1500 or after the step of shaping a strand portion (cf. FIG. 7).

Method 1000′ shown in FIG. 6 preferably also comprises, in step 1800, applying at least one auxiliary structure 200 (cf. FIG. 12) to at least one portion of the first or second continuous food precursor 130, 140. The auxiliary structure is applied here after the step of processing the continuous food precursors 130, 140. It should be understood here, however, that the step of applying the auxiliary structure can also be carried out elsewhere in method 1000′. For example, it is also possible to apply an auxiliary structure to continuous strand 150 or to shaped article 170.

Although FIG. 6 does now show the upstream steps 1010 for providing and processing raw food mass 106, or the downstream steps 1900, these may also form an optional part of method 1000′.

FIG. 7 shows a third embodiment of a method 1000″ for producing a food product 100. To avoid repetitions, only differences from the method according to FIG. 5 are discussed, and reference is made to the above description of the method according to FIG. 5.

Method 1000″ according to the third embodiment differs from method 1000 according to FIG. 5 in that continuous strand 150 is already cut into a strand portion 160 in step 1500 and the step of shaping strand portion 160 into a food product 100 is only subsequently performed in step 1400.

Although FIG. 7 does now show the upstream steps 1010 for providing and processing raw food mass 106, or the downstream steps 1900, these may also form an optional part of method 1000′.

FIG. 8 shows a method 2000 for producing a continuous food precursor 130, 140 (cf. FIG. 1) for producing a food product 100 preferably having a meat-like structure 101 (cf. FIG. 12). In a first step 2100, method 2000 comprises pulling at least a first preliminary food precursor 110 and a second preliminary food precursor 120 in a conveying direction F (cf. FIG. 1).

In a second step 2200, method 2000 comprises orientationally arranging the first preliminary food precursor 110 under traction relative to the second preliminary food precursor 120 orthogonally to the conveying direction in order form an oriented continuous food precursor 130, 140. The first preliminary food precursor 110 and/or the second preliminary food precursor 120 preferably comprise a filament and/or a multifilament and/or a fiber and/or a yarn, wherein the continuous food precursor 130, 140 produced in method 2000 comprises a fiber strip, a fiber bundle or a fiber strand. It should be understood here that the continuous food precursor 130, 140 that is produced can subsequently be used in a method as shown in FIGS. 5 to 7.

FIG. 9 shows a control method 3000 for controlling orientational arranging of continuous food precursors 130, 140 to form a continuous strand 150 (cf. FIG. 1), in a production process as shown in FIGS. 5 to 7 and by means of a food production machine 1 as shown in FIG. 1. In first step 3100, control method 3000 comprises defining a first position P1 in at least one direction orthogonal to the conveying direction F of a continuous food precursor 130 and/or of a second continuous food precursor 140 in relation to at least one second position P2 in the conveying direction (cf. FIG. 11) and alternatively or additionally, an angle α1 (cf. FIG. 11) of the continuous food precursor 130, 140 relative to conveying direction F (cf. FIG. 1). In a second step 3200, control method 3000 further comprises defining a conveying speed v_{F} (cf. FIG. 1) of the first continuous food precursor and/or the second continuous food precursor 140 in conveying direction F. In a third step 3300, control method 3000 further comprises changing first position P1 and/or angle α1 in a time-controlled manner depending on conveying speed v_{F}. The step of changing in a time-controlled manner is carried out in such a way that, orthogonally to conveying direction F, the first continuous food precursor and/or the second continuous food precursor have a variable orientation relative to each other along a longitudinal extension L3 (cf. FIG. 11) of shaped article 170 or food product 100 extending coaxially with conveying direction F.

FIG. 10 shows a continuous strand 150 or strand portion 160 for producing a food product 100 (cf. FIG. 1). Continuous strand 150 comprises a number of first continuous food precursors 130 and a number of second continuous food precursors 140 that are oriented relative to each other in continuous strand 150 and that jointly form a surface 151 of continuous strand 150. Continuous strand 150 and strand portion 160 have a longitudinal extension L2. Continuous strand 150 has a cross-section Q1 with a surface area A. Continuous strand 150 may preferably also comprise further food precursors 131 whose length is shorter than longitudinal extension L2.

FIG. 11 shows a food product 100 or shaped article 170 comprising a number of first continuous food precursors 130 and a number of second continuous food precursors 140 that are oriented relative to each other orthogonally to conveying direction F (cf. FIG. 1). Food product 100 further comprises crosslinking agent 180 and/or stuffing mass 190, which ensures that continuous food precursors 130, 140 are joined to one another. The individual first continuous food precursors 130 are also oriented relative to each other in different ways. In addition, the second continuous food precursors 140 are also oriented relative to each other in different ways. In the view shown, none of the continuous food precursors 130, 140 are arranged parallel to one another. Continuous food precursors 130, 140 have anisotropic material properties M that are retained in continuous strand 150 and also in food product 100.

The second food precursor 140 is respectively defined by a first position P1 orthogonal to the longitudinal extension L3 of food product 100 and by a second position P2 along longitudinal extension L3, and is preferably oriented at an angle α1 relative to conveying direction F and longitudinal extension L3.

FIG. 12 shows a cross-sectional view of food product 100 along sectional plane E orthogonal to conveying direction F. The number of first continuous food precursors 130 have different cross-sections and cross-sectional geometries, which preferably result from processing in continuous precursor processors 41. Method 1000, 1000′, 1000″ according to the invention (cf. FIGS. 5 to 7) for producing food product 100 allows different degrees of fineness, different geometries and different arrangements of continuous food precursors 130, 140 in food product 100 to be realized. The exact arrangement and shaping may also vary along the longitudinal extension L3 of food product 100.

Food product 100 has a cross-section Q2, whereby cross-section Q1 of the continuous strand 150 shown in FIG. 10 has a larger surface area F.

At least one of the first food precursors also has an auxiliary structure 200, which is a structural support, for example.

### LIST OF REFERENCE SIGNS

1 Food processing machine
2 Support device
3 Guide mechanism
4 Processing unit
5 Shaping device
6 Conveyor
7 Cutting device
8 Dispensing unit
21 Storage unit
22 Storage unit
23 Storage unit
31 First guide units (vertical)
31a First plurality of first guide units (vertical)
32 Second guide units (horizontal)
33 Third guide units (vertical)
40 Continuous precursor processor
41 First continuous precursor processing unit (spraying device)
41a Collecting tank
42 Second continuous precursor processing unit (liquid bath)
43 First fluid medium
44 Second fluid medium
46 Strand processing unit
47 Shaped article processing unit
48 Food product processing unit
51 Double-belt press
52 First tool half of the double-belt press
53 Second tool half of the double-belt press
61 Conveyor unit, double belt
62 First conveyor belt
63 Second conveyor belt
100 Food product
101 Meat-like structure
106 Raw food mass
110 First preliminary food precursor
111 Continuous food precursor without parallel orientation
112 Continuous food precursor, woven inside
120 Second preliminary food precursor
130 First continuous food precursor
131 Food precursor
140 Second continuous food precursor
150 Continuous strand
151 Surface of the continuous strand
152 First continuous substrand
153 Second continuous substrand
160 Strand portion
170 Shaped article
180 Binding agent
190 Stuffing mass
200 Auxiliary structure
1000, 1000′, 1000″ Method of producing food products
1010 Upstream steps of the method
1100 First step (pulling)
1200 Second step (orientationally arranging)
1300 Third step (conveying)
1400 Fourth step (forming)
1500 Fifth step (cutting)
1600 Sixth step (dispensing)
1710 Processing in a precursor processor
1720 Processing in a strand processor
1730 Processing in a shaped article processor
1740 Processing in a food product processor
1800 Applying the auxiliary structure
1900 Downstream steps of the method
1910 Packaging
1920 Vacuuming
1930 Heating
1940 Crosslinking
2000 Method of producing food precursors
2100 Pulling the preliminary food precursors
2200 Orientationally arranging the preliminary food precursors
3000 Control method
3100 Defining a position
3200 Defining a conveying speed
3300 Time-controlled changing
P Position
P1 First position
P2 Second position
L1 Longitudinal extension of the guide unit
L2 Longitudinal extension of the continuous strand or strand portion
L3 Longitudinal extension of the food product (100)
α Angle
α1 First angle
F Conveying direction
E Cross-sectional plane
D Compressive forces
D1 Compressive force component
Z Tractive forces
Z1 Force component
S Shearing forces
Q1 Cross-sectional area of the continuous strand
Q2 Cross-sectional area of the food product (100)
T_{V} Crosslinking temperature
t_{V} Crosslinking duration
T_{Vo} Cauterization temperature
M Material properties
A Surface area

1. A method for producing a food product, the method comprising:
pulling a first continuous food precursor and a second continuous food precursor in a conveying direction;
arranging the first continuous food precursor relative to the second continuous food precursor and orthogonally to the conveying direction to form a continuous oriented strand;
conveying the continuous strand toward a shaping device via tractive forces in the conveying direction;
applying compressive forces having at least one compressive force component orthogonal to the conveying direction to a first portion of the continuous strand with the shaping device to form a shaped article;
cutting the continuous strand to form a strand portion from a second portion of the continuous strand and a food product from the shaped article; and
dispensing the shaped article and the food product from the shaping device.

2. The method of claim 1, wherein forming the shaped article is carried out in a continuous shaping tool and applying the compressive forces is performed at least one of progressively and evenly on a surface of the continuous strand.

3. The method of claim 1, wherein the step of pulling the first continuous food precursor and the second continuous food precursor in the conveying direction comprises at least one of:
pultruding at least one of the first continuous food precursor and the second continuous food precursor from a production device via a tractive force having at least one force component in the conveying direction;
unrolling at least one of the first continuous food precursor and the second continuous food precursor from a first storage device via a tractive force having at least one force component in the conveying direction, the first storage device is being configured to receive the at least one of the first continuous food precursor and the second continuous food precursor in a rolled-up state; and
pultruding at least one of the first continuous food precursor and the second continuous food precursor from a second storage device via a tractive force having at least one force component in the conveying direction, the second storage device being configured to receive the at least one of the first continuous food precursor and the second continuous food precursor in a randomized state.

4. The method of claim 1, wherein the first and second continuous food precursors are conveyed in the conveying direction via a plurality of guide units, the guide units each being configured to deflect at least one of the first continuous food precursor and the second continuous food precursor orthogonally to the conveying direction such that the first continuous food precursor and the second continuous food precursor have a variable orientation relative to each other along a longitudinal extension of the continuous strand extending coaxially with the conveying direction.

5. The method of claim 4, further comprising controlling at least one of a position and an angle of at least one of the guide units such that the first continuous food precursor and the second continuous food precursor have the variable orientation relative to each other along the longitudinal extension of the continuous strand.

6. The method of of claim 3, wherein the first storage device includes at least two storage units for receiving at least one of the first continuous food precursor and the second continuous food precursor, a position of each storage unit relative to the conveying direction being controllable for oriented arrangement of at least one of the first continuous food precursor and the second continuous food precursor; and
wherein the method further comprises controlling the position of at least one storage unit such that the first continuous food precursor and the second continuous food precursor have a variable orientation relative to each other and orthogonally to the conveying direction along a longitudinal extension of the continuous strand extending coaxially with the conveying direction.

7. The method of claim 3, wherein the first storage device has at least two storage units for receiving at least one of the first continuous food precursor and the second continuous food precursor, an angle of each storage unit relative to the conveying direction is being controllable for oriented arrangement of at least one of the first continuous food precursor and the second continuous food precursor; and
wherein the method further comprises controlling the angle of at least one storage unit such that the first continuous food precursor and the second continuous food precursor have a variable orientation relative to each other and orthogonally to the conveying direction along a longitudinal extension, of the continuous strand extending coaxially with the conveying direction.

8. The method of claim 3, wherein the first storage device includes at least two storage units for receiving at least one of the first continuous food precursor and the second continuous food precursor, the storage units each having a longitudinal extension and a cross-section varying along the longitudinal extension such that the first continuous food precursor and the second continuous food precursor have a variable orientation relative to each other and orthogonally to the conveying direction along a longitudinal extension of the continuous strand extending coaxially with the conveying direction.

9. The method of claim 1, wherein at least one of the first continuous food precursor and the second continuous food precursor are conveyed via at least two guide units, the guide units each having a longitudinal extension and a varying cross-section along the longitudinal extension such that the first continuous food precursor and the second continuous food precursor have a variable orientation relative to each other and orthogonally to the conveying direction along a longitudinal extension of the continuous strand extending coaxially with the conveying direction.

10. The method of claim 1, wherein the step of arranging the first continuous food precursor relative to the second continuous food precursor and orthogonally to the conveying direction to form a continuous oriented strand comprises at least one of:
arranging a plurality of first continuous food precursors to form at least one oriented first continuous substrand;
arranging a plurality of second continuous food precursors to form at least one oriented second continuous substrand; and
arranging the at least one first continuous substrand relative to at least one of the at least one second continuous substrand and the second continuous food precursors; and
arranging the at least one second substrand relative to at least one of the at least one first continuous substrand and the first continuous food precursors.

11. The method of claim 1, comprising
applying at least one auxiliary structure to at least a portion of at least one of the first continuous food precursor, the second continuous food precursor, and the continuous strand.

12. The method of claim 11, wherein the auxiliary structure includes an auxiliary guiding structure configured to arrange the first continuous food precursor and the second continuous food precursor in bundles within the auxiliary guiding structure.

13. The method of claim 11, wherein the auxiliary structure includes an auxiliary conveying structure configured to reduce peak stresses during at least one of pulling of the first continuous food precursor and the second continuous food precursor in the conveying direction and conveying of the continuous strand in the direction of the shaping device.

14. The method of claim 11, wherein the auxiliary structure includes a structural support configured to at least one of form a structure in the shaped article and support structural formation of the shaped article.

15. The method of claim 1, conveying the continuous strand in the direction of the shaping device comprises at least one of:
applying tractive forces in the conveying direction to at least one of the continuous strand and the shaped article;
applying shearing forces in the conveying direction to a surface of at least one of the first continuous food precursor, the second continuous food precursor, the continuous strand, and shaped article;
conveying the continuous strand in the conveying direction into the shaping device via at least one conveyor;
conveying the continuous strand into the shaping device via tractive forces;
conveying at least one of the first continuous food precursor, the second continuous food precursor, and the continuous strand via gravity; and
conveying the strand portion into the shaping device.

16. The method of claim 1, wherein the tractive forces are applied to at least one of the continuous strand and the first continuous food precursor and the second continuous food precursor via a conveyor.

17. The method of claim 16, wherein the conveyor includes at least one of:
a first conveyor unit configured to apply tractive forces in the conveying direction to at least one of the first continuous food precursor, the second continuous food precursor, the continuous strand, and the shaped article; and
a second conveyor unit configured to apply shearing forces to at least one of the first continuous food precursor, the second continuous food precursor, the continuous strand, and the shaped article.

18. The method of claim 1, further comprising at least one of:
processing at least one of the first continuous food precursor and the second continuous food precursor in continuous precursor processor;
processing at least one of the continuous strand and the strand portion in a strand processor;
processing the shaped article in a shaped article processor; and
processing the food product in a food product processor.

19. The method according to claim 18, wherein the continuous precursor processor includes at least one continuous precursor processing unit and the method further comprises at least one of:
twisting at least one of the first continuous food precursor and the second continuous food precursor in a twisting unit;
stretching at least one of the first continuous food precursor and the second continuous food precursor in a stretching unit;
extending at least one of the first continuous food precursor and the second continuous food precursor in an extending unit;
conditioning at least one of the first continuous food precursor and the second continuous food precursor in a conditioning unit;
cooling or heating at least one of the first continuous food precursor and the second continuous food precursor in a tempering unit;
drying at least one of the first continuous food precursor and/or the second continuous food precursor in a drying unit;
texturising at least one of the first continuous food precursor and the second continuous food precursor in a texturising unit;
wetting at least one of the first continuous food precursor and the second continuous food precursor with at least one of a binding agent, a dye, and a sizing agent in a wetting unit;
vapor coating at least one of the first continuous food precursor and the second continuous food precursor with at least one of fluids, flavoring, and dye in a vapor coating unit;
powder coating at least one of the first continuous food precursor and the second continuous food precursor with a functional powder in a powder coating unit; and
squeezing at least one of the first continuous food precursor and the second continuous food precursor to release at least one of an excess binding agent and an excess crosslinking agent in a squeezing unit.

20. The method of claim 18, wherein the strand processor includes at least strand processing unit and the method further comprises at least one of:
cooling or heating the continuous strand in a tempering unit;
drying the continuous strand in a drying unit;
texturising the continuous strand in a texturising unit;
powder coating the continuous strand with a functional powder in a powder coating unit;
squeezing the continuous strand to release at least one of an excess binding agent and an excess crosslinking agent in a squeezing unit; and
infusing the continuous strand with at least one of fluids, fat, and an enzymatic solution in an infusing unit.

21. The method of claim 18, wherein the shaped article processor includes at least one shaped article processing units and the method further comprises at least one of:
infusing the shaped article with at least one of fluids, fat, binding agents, an enzymatic solution, and imitation blood in an infusing unit; and
coating the shaped article with at least one functional surface coating in a coating unit.

22. The method of claim 18, wherein the food product processor includes at least one food product processing unit and the method further comprises at least one of:
infusing the food product with at least one of fluids, fat, flavoring, dye, hydrocolloids, proteins, polysaccharides, and an enzymatic solution in an infusing unit; and
coating the food product with a functional surface coating in a coating unit.

23. The method of claim 1, further comprising
packaging the food product in a vacuum-tight packaging and at least one of
vacuuming the vacuum-tight packaging;
heating the food product to a crosslinking temperature and maintaining the crosslinking temperature for a crosslinking duration; and
crosslinking the food product with a crosslinking agent.

24. The method of claim 23, wherein vacuuming the vacuum-tight packaging defines a final shape of the food product.

25. The method of claim 1, further comprising at least one of:
heating a surface of at least one of the continuous strand and the strand portion above a cauterization temperature to prevent at least one of enzymatic crosslinking and chemical crosslinking near the surface; and
freezing the surface of the at least one of the continuous strand and the strand portion to prevent at least one of enzymatic crosslinking and chemical crosslinking near the surface.

26. The method of claim 1, further comprising
providing a raw food mass containing at least one of a plant-based protein and a fat; and
shaping the raw food mass into the first continuous food precursor and the second continuous food precursor by at least one of dry extrusion, high moisture extrusion, a spinning process, microextrusion, a textile surface formation process, a shear chamber technique, a depositing technique, a yarn-forming technique, and a nonwoven laying technique using mycelium.

27. The method of claim 1, wherein at least one of the first continuous food precursor and the second continuous food precursor comprise at least one of a filament, a multifilament, a fiber strip, a fiber, a fiber bundle, a polymer film, a fiber strand; and
wherein a composition the first continuous food precursor differs from a composition of the second continuous food precursor.

28. A method of producing a continuous food precursor for producing a food product, the method comprising:
pulling a first preliminary food precursor and a second preliminary food precursor in a conveying direction; and
arranging the first food precursor under traction relative to the second preliminary food precursor and orthogonally to the conveying direction to form a continuous oriented food precursor;
wherein at least one of the first preliminary food precursor and the second preliminary food precursor comprise at least one of a filament, a multifilament, a fiber, and a yarn and is a fiber strip, a fiber bundle, or a fiber strand.

29. The method according to claim 28, further comprising
applying at least one auxiliary structure to at least a portion of at least one of the first preliminary food precursor and the second preliminary food precursor, the auxiliary structure including an auxiliary guiding structure, an auxiliary conveying structure, and a structure support;
wherein the auxiliary guiding structure is configured to arrange the first preliminary food precursor and the second preliminary food precursor in bundles;
wherein the auxiliary conveying structure is configured to reducing peak stresses during pulling of the first preliminary food precursor and the second preliminary food precursor in the conveying direction; and
wherein the structural support is configured to form a structure in the continuous food precursor.

30. A method for controlling the orientational arranging of continuous food precursors to form a continuous strand for the production of a food product, the method comprising:
defining at least one of a first position in at least one direction orthogonal to a conveying direction of a first continuous food precursor and a second continuous food precursor in relation to a second position of the first continuous food precursor and the second continuous food precursor in the conveying direction and an angle of the first continuous food precursor and the second continuous food precursor relative to a the conveying direction of the first continuous food precursor and the second continuous food precursor;
defining a conveying speed of the first continuous food precursor and the second continuous food precursor in the conveying direction (F); and
changing at least one of the first position and the angle in a time-controlled manner based upon the conveying speed such that the first continuous food precursor and the second continuous food precursor have a variable orientation relative to each other along a longitudinal extension of the continuous strand extending coaxially with the conveying direction.

31. A food product comprising:
a at least two first continuous food precursors;
and at least two second continuous food precursors;
wherein the first and second continuous food precursors are arranged relative to each other orthogonally to a longitudinal extension of the food product;
wherein at least one of the first continuous food precursors and the second continuous food precursors have anisotropic material properties and at least a portion of at least one of the first continuous food precursors and the second continuous food precursors extend along an entirety of the longitudinal extension.

32. The food product of claim 31, wherein at least a portion of at least one of the first continuous food precursors and the second continuous food precursors are stretched at least in sections along the longitudinal extension of the food product.

33. A food production machine for producing a food product, the food production machine comprising:
a conveyor configured to pull at least a first continuous food precursor and a second continuous food precursor in a conveying direction;
a storage device configured to store the first continuous food precursor and the second continuous food precursor;
a guide mechanism configured to orientationally arrange the first continuous food precursor relative to the second continuous food precursor and orthogonal to the conveying direction to form a continuous oriented strand;
a shaping device configured to apply compressive forces orthogonally to the conveying direction to a first portion of the continuous strand to form a shaped article; and
a cutting device configured to cut the continuous strand to form a strand portion from a second portion of the continuous strand and a food product from the shaped article;
a dispensing unit configured to dispense the shaped article and the food product from the shaping device; and
wherein conveyor is configured to convey the continuous strand toward the shaping device via tractive forces in the conveying direction.

34. The food production machine of claim 33, wherein at least one conveyor unit of the conveyor is downstream of the shaping device in the conveying direction.
